(19) United States
(12) Patent Application Publication
(10) Pub. No.: US 2026/0264240 A1
(43) Pub. Date: Sep. 10, 2026

(54) ROBOT SYSTEM

(71) Applicant: NACHI-FUJIKOSHI CORP., Tokyo (JP)

(72) Inventor: Hiroki MURAKAMI, Toyama-shi (JP)

(21) Appl. No.: 19/538,254

(22) Filed: Feb. 12, 2026

(30) Foreign Application Priority Data
Mar. 6, 2025 (JP) 2025-035256

(51) Int. Cl. B25J 9/16

(52) U.S. Cl. CPC B25J 9/1666; B25J 9/1676; B25J 9/1692

(57) ABSTRACT

A robot system includes a robot, a sensor, and a controller. The controller calculates positional information of each part of the robot based on link parameters of the robot and calculates the position of an object based on measurement value of the sensor. The processor restricts movement of the robot when at least one of the following conditions is determined affirmatively: if a first distance between a tool center point and a point representing the position of the object is smaller than a first threshold, if a second distance between an upper arm line segment and the point representing the position of the object is smaller than a second threshold and if a third distance between a lower arm line segment and the point representing the position of the object is smaller than a third threshold.

### RELATED APPLICATIONS

This application claims priority to Japanese Patent Application No. JP2025-035256, filed on Mar. 6, 2025, the entire content of which is incorporated herein by reference.

### BACKGROUND OF THE INVENTION

### 1. Field of the Invention

The present invention relates to a robot system that detects an approaching moving object such as a human.

### 2. Description of the Related Art

In recent years, collaborative robots have been studied that work in collaboration with human workers without need to set up safety fences for protecting the human workers. One of the safety measures that has been studied to ensure safety of a human working with collaborative robots is provided by the technology implemented to detect an approaching moving object such as a human. For example, Japanese Patent Application Laid-Open Publication No. 2022-136318 (Patent Document 1) discloses a robot controller that detects an approaching moving object. The robot controller in Patent Document 1 can detect a relative distance or relative approaching speed between the moving object and the robot using a sensor set to a tool which is attached to the distal end of the robot.

### SUMMARY OF THE INVENTION

However, since the sensor of Patent Document 1 is set to the tool attached to the robot arm, the area around the robot arm becomes a blind area for the sensor that hinders the reliable detection of a moving object approaching the robot arm.

The present invention was made in view of the above-mentioned problems. It is an object of the present invention to provide a robot system that can reliably detect a moving object approaching a tool set to the robot and the robot arm.

A robot system according to the present invention includes a robot having a base, a robot arm including a lower arm joined to the base and an upper arm joined to the lower arm, and a tool joined to the upper arm, at least one sensor and a controller. The sensor is operable to sense a monitoring range and obtain measurement values indicating a distance to an object that is present in the monitoring range. The controller includes at least one processor and at least one memory. The memory stores in advance link parameters of the robot. The processor is programmed to control the operation of the robot subsequent to starting the operation of the robot and recursively perform a monitoring process. In the monitoring process, the processor is programmed to calculate positional information of each part of the robot based on link parameters of the robot and calculate the position of the object based on measurement values of the sensor. The processor is programmed to execute an approach determination process in which a first condition is to determine if a first distance between a tool center point indicating a center position of the tool and a point representing the position of the object is smaller than a first threshold, a second condition is to determine if a second distance between an upper arm line segment representing a longitudinal length and a position of the upper arm and the point representing the position of the object is smaller than a second threshold, and a third condition is to determine if a third distance between a lower arm line segment representing a longitudinal length and a position of the lower arm and the point representing the position of the object is smaller than a third threshold. When at least one of the first condition, the second condition, and the third condition is determined affirmative, the processor is programmed to restrict movement of the robot.

Positions of both ends of the upper arm line segment and both ends of the lower arm line segment may constitute the origins of coordinate systems of joints of the robot.

Also, the memory may store in advance an exclusion area where the approach determination process is not performed. The processor may use a projection method to determine whether the point representing the position of the object is located outside or inside the exclusion area. If the point representing the position of the object is determined located outside the exclusion area, the processor may perform the approach determination process. If the point representing the position of the object is determined located inside the exclusion area, the processor may dispense with performing the approach determination process.

The present invention can provide a robot system that can reliably detect an approach of a moving object regarding both a tool and an arm.

### BRIEF DESCRIPTION OF THE DRAWINGS

FIG. 1 is a view showing an overall configuration of a robot system according to an embodiment of the present invention.

FIG. 2 is a block diagram showing a functional configuration of the robot system of FIG. 1.

FIG. 3 is a schematic view for explaining monitoring ranges of sensors of FIG. 1.

FIG. 4 is a schematic view for explaining origins of coordinate systems of respective parts of a robot of FIG. 1.

FIG. 5 is a flow chart showing an exemplary monitoring process executed by a controller of FIG. 1.

FIG. 6 is a schematic view explaining a determination process regarding an exclusion area of step S7 of FIG. 5.

FIG. 7 is a schematic view explaining the determination method regarding the exclusion area of step S7 of FIG. 5.

FIG. 8 is a schematic view explaining distances related to three approach determination conditions.

### DETAILED DESCRIPTION OF THE PREFERRED EMBODIMENTS

Hereinafter, embodiments of the present invention will be described with reference to the accompanying drawings. The drawings are schematic in nature just for the purpose of explaining the embodiments and do not represent the actual shapes and sizes, as well as the actual positional relationships, of what are illustrated in the drawings The embodiments of the present inventions are not limited to the examples shown in the drawings.

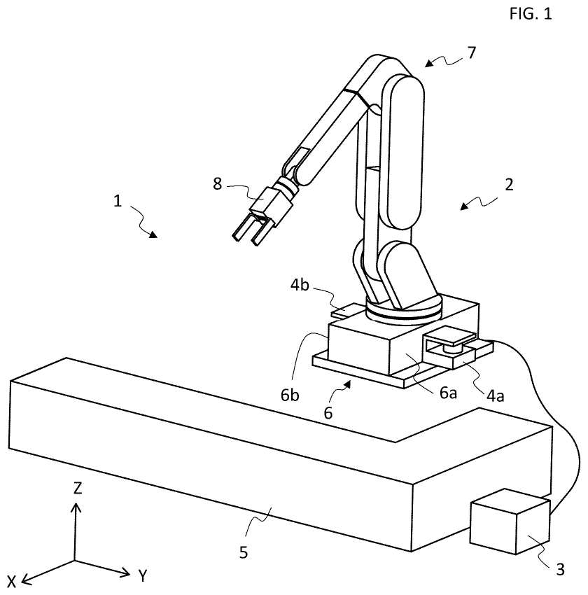

FIG. 1 is a view showing an overall configuration of a robot system according to an embodiment of the present invention. As shown in FIG. 1, a robot system 1 includes a robot 2, a controller 3 for controlling the operation of the robot 2, and sensors 4a and 4b for measuring a distance to an object from the positions of the robot 2. Examples of the object include pre-installed objects for use in performing preprogrammed works and moving objects such as a human. In FIG. 1, an L-shaped workbench 5 is installed in front of the robot 2. The workbench 5 may be a table on which a workpiece (not shown) or the like is placed.

The Z axis shown in FIG. 1 shows a vertical direction. The X axis and the Y axis shown in FIG. 1 intersect orthogonally with each other and with the Z axis. That is, a plane formed by the X and Y axes extends orthogonally with the vertical direction. The robot 2 is installed on a plane that generally extends orthogonally with the vertical direction.

The robot 2 is a vertical articulated robot with six joints, for example. The robot 2 includes a base 6 installed on the floor or the like, a robot arm 7 that is joined to the base 6, and a tool 8 that is attached to the distal end of the arm 7. The robot arm 7 is configured with a plurality of joints and a plurality of links movable by link mechanisms. Each of the joints joins a pair of adjacent links and is driven by a power mechanism (motor, speed reducer, bearing, gear, etc.) to rotate the pair of links relative to each other. The tool 8 is in a form of a gripping hand that can grip a workpiece or the like, for example. The embodiments of the present invention are implementable with any number of joints or any types of the tool 8 of the robot 2.

The controller 3 is operably connected to the robot 2 and other devices such as the sensors 4a and 4b. The controller 3 may be connected to the devices via a wired communication cable or may be connected wirelessly to the devices. The controller 3 may be stored inside the robot 2 or may be installed away from the robot 2. Also, the controller 3 may be configured with more than one controller. When it is configured with more than one controller, these controllers are operably connected to each other. In FIG. 1, the controller 3 is installed away from the robot 2 and the controller 3 consists of one controller.

The sensors 4a and 4b irradiate laser light within a fixed range, called a monitoring range, in a generally horizontal direction (i.e. in a direction generally parallel to the plane on which the robot 2 is installed) and measure distances to an object detected at each of the irradiation angles of the laser light. That is, the sensors 4a and 4b are operable to sense the monitoring range and obtain measurement values indicating the distance to the object that is present in the monitoring range. The sensors 4a and 4b are, for example, safety devices each in a form of a safety laser scanner. The sensors 4a and 4b each project a laser beam light by a projector, each receive by a light receiver a light reflected at the object, and each measure a time interval from the irradiation of the laser beam to the reception thereof to calculate a distance to the position from the sensor position. The sensors 4a and 4b can detect the presences of surrounding objects by calculating the distances to the objects by scanning a fan-shaped area at a scanning angle that is changed little by little.

The sensors 4a and 4b are placed on a left side face 6a and a right side face 6b of the base 6 of the robot 2, respectively, for example. Although FIG. 1 shows two sensors, i.e., the sensors 4a and 4b, there may be only one sensor or three or more sensors provided with the robot 2. The embodiments of the present invention, are implementable with the sensors 4a and 4b installed at any locations. Also, the sensors 4a and 4b do not have to be adopted in the form of the safety laser scanners, and may be ones that emit radio waves such as a millimeter wave radar, or imaging devices such as 3D cameras. The sensors 4a and 4b may be any sensors that can measure a distance to an object from positions of the robot 2 and detect the presence of the object around the robot 2.

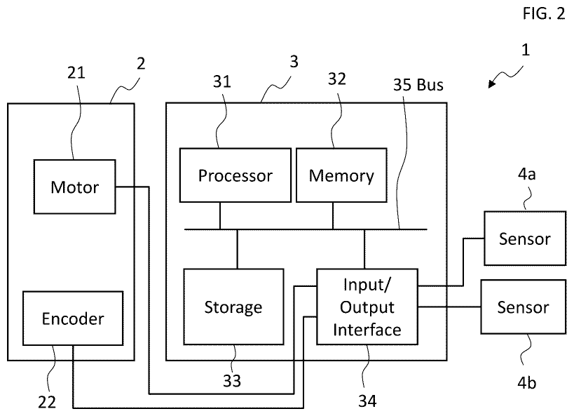

FIG. 2 is a block diagram showing a functional configuration of the robot system of FIG. 1. The robot 2 includes, at each of the joints thereof, a motor 21 that rotates according to instructions from the controller 3, and an encoder 22 that detects a rotational angle of the motor 21 and outputs to the controller 3 a signal indicative of an axial angle of each joint axis.

The controller 3 has a processor 31, a memory 32, a storage 33, and an input/output interface 34 all of which are connected to each other via a bus 35. The processor 31 is formed with a CPU (Central Processing Unit) or the like, and reads out a computer program stored in advance in the storage 33 or the like, deploys the computer program in the memory 32 and sequentially executes a plurality of commands of the deployed computer program. The memory 32 is formed with a volatile memory such as a semiconductor memory, and takes a form of a storage device, to or from which the processor 31 can directly read and write data. The storage 33 is formed with a computer-readable non-transitory storage medium such as a hard disk drive, solid state drive, or USB (Universal Serial Bus) memory, and stores computer programs and data therein. The input/output interface 34 functions as an external connection device used for inputting and outputting signals to and from the robot 2, the sensors 4a, 4b, and the like.

The functions of the controller 3 may be realized at least in part by a logic circuit or an analog circuit. Also, the controller 3 may execute various programs using an electronic circuit such as an FPGA (Field Programmable Gate Array). The controller 3 may further include devices, such as a wireless communication device and a speaker, which are not shown in FIG. 2.

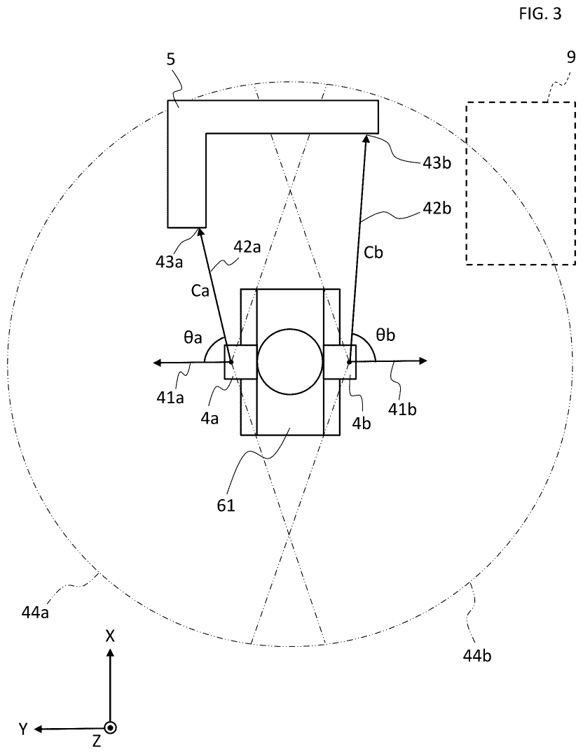

FIG. 3 is a schematic view for explaining monitoring ranges of the sensors of FIG. 1, and is a schematic view of the robot 2 viewed from above in the Z axis (i.e. from above in the vertical direction). FIG. 3 does not show the arm 7, the tool 8 of the robot 2 or the controller 3 but only shows the base 6 and the sensors 4a and 4b of the robot 2, and the workbench 5. The maximum irradiation angle range of the sensors 4a and 4b is 270°, for example. Since the sensors 4a and 4b are installed on the opposite side faces 6a and 6b of the base 6, the sensors 4a and 4b can monitor almost the entire angles surrounding the robot 2 in the horizontal direction. Even where the sensors 4a and 4b are installed distant from the robot 2, the sensors 4a and 4b positioned opposite to each other with respect to the robot 2 can monitor almost the entire angles surrounding the robot 2 in the horizontal direction. The number and the positions of the sensors may be determined so that the sensors can monitor almost the entire angles surrounding the robot 2 in the horizontal direction.

The irradiation angles of the sensors 4a and 4b are shown as angles θa and θb formed between reference directions 41a and 41b and laser light irradiation directions 42a and 42b, respectively. Monitoring ranges 44a and 44b of the sensors 4a and 4b are defined by monitoring distances (within the maximum irradiation distances of the sensors 4a and 4b) and monitoring angle ranges (within the maximum irradiation angle ranges of the sensors 4a and 4b). Measurement values Ca and CBS of the sensors 4a and 4b represent distances from the irradiation positions of the laser lights to points 43a and 43b at which the laser lights are reflected by the object. The measurement values Ca and cob of the sensors 4a and 4b shown in FIG. 3 represent the distances to the workbench 5. When there is no object present in the monitoring distance, the measurement values Ca and cub of the sensors 4a and 4b are equal to the monitoring distance. Note that the laser lights of the sensors 4a and 4b extend in the Z axis by predetermined irradiation angle ranges of laser light emission parts of the sensors 4a and 4b taken as the center.

The method for detecting a moving object using the sensors 4a and 4b, which will be described below, is not purported to determine whether the moving object is a human or not. In addition to a human, examples of moving objects detectable by the sensors 4a and 4b include nearby devices with a movable part such as a piston and load transporting robots other than the robot 2. Also, certain movements of the robot 2 make the robot 2 itself detectable as an obstructing moving object in the monitoring plane of the sensors 4a and 4b. Thus, the processor 31 of the controller 3 establishes, in advance in the storage 33, an exclusion area 9 where sensing of an approaching moving object is absolved, which will be described below and reads out, from the memory 32, the established exclusion area 9 when sensing an approaching moving object.

In FIG. 3, the exclusion area 9 is defined as an area where a transporting robot, other than the robot 2, enters. The shape of the exclusion area 9 is not limited to a rectangular shape and may be defined in any polygonal shapes. The processor 31 stores in the storage 33 coordinates of the apexes of the defined polygonal shape representative of the exclusion area 9. The processor 31 may receive an input indicative of the coordinates of the apexes of the exclusion area 9 via a teaching pendant (not shown) or the like, or may move the tool 8 of the robot 2 to teach each of the coordinates and store in the storage 33 the tool center point representative of the exclusion area 9.

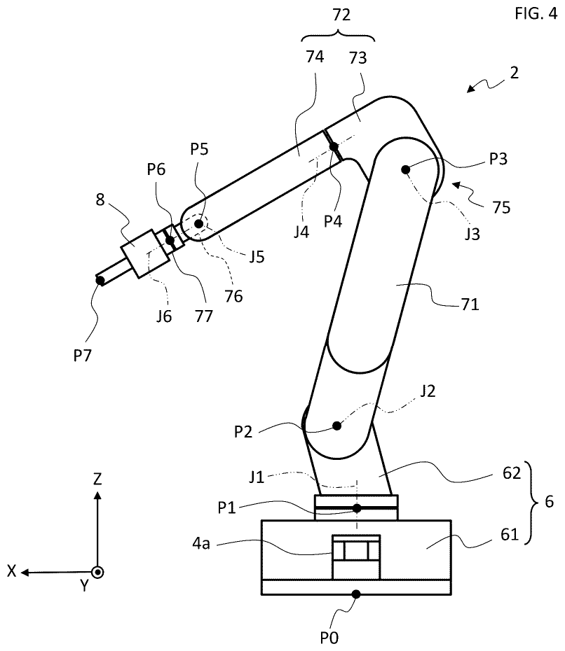

FIG. 4 is a schematic view for explaining the origin of the coordinate system in which the positions of the respective parts of the robot of FIG. 1 are defined. FIG. 4 shows a left side view of the robot 2 viewed from the positive side of the Y axis. The base 6 of the robot 2 includes a foundation base 61 fixed to the floor and a revolving base 62 (a first link) attached to the foundation base 61. The revolving base 62 can revolve (rotate) around a first rotational axis J1 extending in the Z axis direction.

The arm 7 of the robot 2 includes a lower arm 71 and an upper arm 72. The lower arm 71 (a second link) has longitudinal ends, where with one longitudinal end being joined to the revolving base 62 and the other end being joined to the upper arm 72 and rotatable around a second rotational axis J2 extending in the Y axis direction.

The upper arm 72 has longitudinal ends with one longitudinal end being joined to the lower arm 71 and the other end being joined to a wrist portion 76 and rotatable around a third rotational axis J3 extending in the Y axis direction. The upper arm 72 includes a first upper arm 73 (a third link) joined to the lower arm 71 and a second upper arm 74 (a fourth link) joined to the first upper arm 73. The first upper arm 73 and the second upper arm 74 have generally the same center axes extending in the longitudinal direction. The first upper arm 73 is rotatable around the third rotational axis J3 extending in the Y axis direction. The second upper arm 74 is rotatable around a fourth rotational axis J4 extending in the longitudinal direction of the second upper arm 74. A joint joining the lower arm 71 and the upper arm 72 forms an elbow portion 75 of the robot 2. The elbow portion 75 of the robot 2 is a part of the arm 7 that is sensed as a conspicuous edge during the operation of the robot 2.

The tool 8 has a longitudinal length and is joined to the second upper arm 74 via the wrist portion 76 and an attachment portion 77. The wrist portion 76 (a fifth link) is joined to the second upper arm 74 and is rotatable around a fifth rotational axis J5 extending in the Y axis direction. The attachment portion 77 (a sixth link) has an attachment surface to which the tool 8 is attached and is rotatable around a sixth rotational axis J6. The tool 8 extends along a longitudinal center axis coaxially with the sixth rotational axis J6 when the tool 8 is attached to the attachment surface of the attachment portion 77.

A point P0 is the origin of the coordinate system (also called the robot coordinate system) 20 of the base 6. Points P1 to P6 are the origins of the joint coordinate systems (also called link coordinate systems) 21 to 26 relating to the first rotation axis J1 to the sixth rotation axis J6, respectively. A point P7 is the origin of the coordinate system (also called a tool coordinate system) 27, that is, the tool center point indicative of the center of the tool 8.

The processor 31 of the controller 3 stores link parameters representing relationships between the coordinate systems 20 to 27 in the storage 33 in advance and reads out the link parameters of the robot 2 and deploys them in the memory 32 when executing the process described below. For notation of the link parameters, Denavit-Hartenberg convention (D-H convention) is known, for example.

The coordinate systems using D-H convention are defined as follows:
1. The links and the joints are sequentially numbered from those nearer from the base of the robot 2.
2. A link i defines the coordinate system Σ[i] in which a joint axis i is coincide with a Z [i] axis.
3. The x [i] axis is defined such that it is normal commonly to the z [i] axis and a z [i+1] axis and a direction toward the z [i+1] axis is positive.
4. A y [i] axis is defined to follow the right-handed coordinate system.
5. The link parameters include the following four parameters:
   (1) A link length a [i]=a distance from the z [i−1] axis to the z [i] axis along the x [i−1] axis;
   (2) A link twist angle α [i]=an angle from the z [i−1] axis to the z [i] axis around the x [i−1] axis;
   (3) The distance between two links d [i]=a distance from the x [i−1] axis to the x [i] axis along the z [i] axis; and
   (4) The angle between two links 0 [i]=an angle from the x [i−1] axis to the x [i] axis around the z [i] axis.

The link parameters that are read out and deployed in the memory 32 in advance include the distance between the links, the link twist angle and the link length, which are treated as constants. The last link parameter, which is the angle between the links, corresponds to an axial angle of each joint axis and is treated as a variable that changes according to the movement of the robot 2. The processor 31 receives a measurement value of the respective joint axes from the encoder 22 and calculates a position of each part of the robot 2 using a forward kinematics calculation.

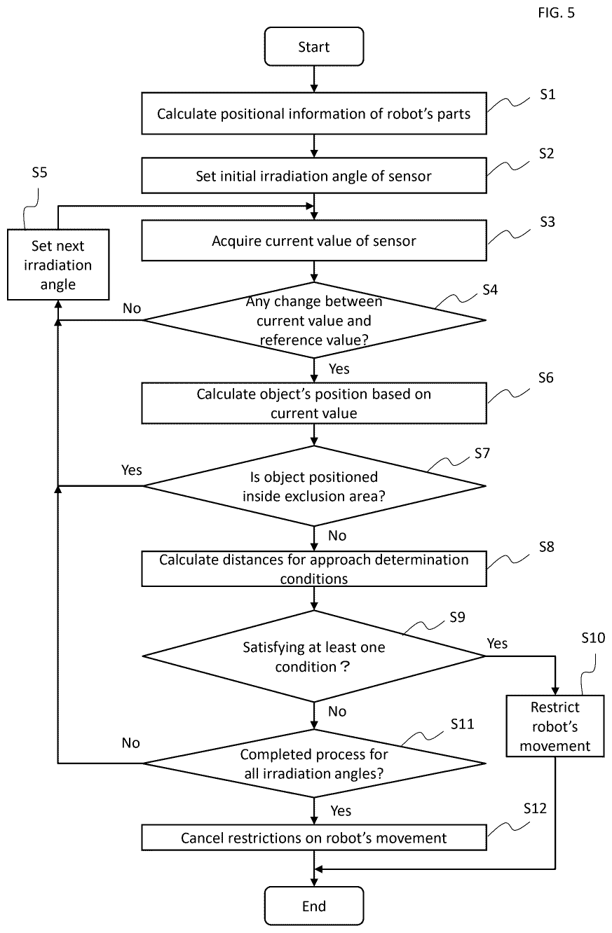

FIG. 5 is a flow chart showing an exemplary monitoring process executed by the controller of FIG. 1. The controller 3 executes the monitoring process shown in FIG. 5 at a regular processing interval during the operation of the robot 2. That is, subsequent to starting the operation of the robot 2, the controller 3 recursively performs the monitoring process at the regular processing interval.

As shown in FIG. 5, the processor 31 of the controller 3 calculates the positional information for each part of the robot 2 based on the link parameters using the forward kinematics calculation (step S1). The link parameters, i.e., an axial angle of the respective joint axes, which is received from the encoder 22, and a distance between two links, a link twist angle, and a link length, are read out and deployed in the memory 32 in advance. The positions of the parts of the robot 2 represent points P1 to P7 shown in FIG. 4, which constitute the origins of the coordinate systems of the joints and the tool center point of the robot 2.

Next, the processor 31 sets an initial irradiation angle for the sensor 4a (or 4b), for example (step S2). Next, the processor 31 acquires a current measurement value of the sensor 4a (or 4b) relating to the set irradiation angle (step S3). The processor 31 stores in the memory 32 the current measurement value of the sensor 4a (or 4b) as a reference value for detecting a change in the circumstance surrounding the robot 2 for each irradiation angle. The current measurement value stored in the memory 32 is referred to as the reference value used in a determination made in step S4 of a next loop formed by steps S3, S4 and S5.

Next, the processor 31 checks whether or not there is a change in the circumstance surrounding the robot 2 (step S4). Specifically, the processor 31 determines whether there is a change between the current measurement value of the sensor 4a and the stored reference value of the sensor 4a that was measured at the same irradiation angle. If the laser light of the sensor 4a hits a moving object for the first time, the current measurement value becomes different from the stored reference value. The processor 31 determines in each of recursively executed steps S4 whether or not the laser light of the sensor 4a (or 4b) hits a moving object. More specifically, the processor 31 determines whether or not the difference between the current measurement value of the sensor 4a (or 4b) and the reference value of the sensor 4a (or 4b) measured at the same irradiation angle is equal to or greater than a threshold value. If there is no change between the current value and the reference value (‘No’ in step S4), the processor 31 update the irradiation angle of the sensor 4a (or 4b) (step S5) to a next irradiation angle and repeats the process from step S3. If there is a change between the current value and the reference value (‘Yes’ in step S4), the processor 31 proceeds to step S6.

In step S4, instead of using the measurement value from the previous loop stored in the memory 32 in step S2, the processor 31 may use, as the reference value, an initial measurement value of the sensor 4a (or 4b) measured before the robot 2 starts its operation. In such arrangement, the processor 31 performs the monitoring process by first performing the sensing with the sensor 4a at one irradiation angle after another to complete the sensing of the monitoring range 44a, and then performing the sensing with the sensor 4b at one irradiation angle after another to complete the sensing of the monitoring range 44b, thereby completing the sensing of the environment surrounding the robot 2. The processor 31 stores the initial measurement value measured at each irradiation angle in the memory 32 in advance. Although this process is performed every time there is a change in the environment surrounding the robot 2, since the controller 3 automatically performs the process, the user does not have to make any complicated preparation for manually storing the measurement values in advance.

In step S6, the processor 31 calculates the position of an object (a moving object) based on the current measurement value of the sensor 4a (or 4b) acquired in step S3. As described above referring to FIG. 3, the measurement value Ca (or Cb) of the sensor 4a (or 4b) is the distance from the irradiation position of the laser light to the point 43a (or 43b) at which the laser light is reflected by the object. The processor 31 calculates the position of the object in the initial coordinate system 20 based on the irradiation angle θa (or θb) indicating the direction, the measurement value Ca (or Cb) indicating the distance and the positional relationship between the origin of the initial coordinate system 20 and the irradiation position of the laser light.

Next, the processor 31 checks whether or not the point representing the position of the object (the moving object) calculated in step S6 is located inside an exclusion area 9 (step S7). If the point representing the position of the object is located inside the exclusion area 9 (‘Yes’ in step S7), the processor 31 sets the irradiation angle of the sensor 4a (or 4b) (step S5) to a next irradiation angle and repeats the process from step S3. On the other hand, if the point representing the position of the object is located outside the exclusion area 9 (‘No’ in step S7), the processor 31 proceeds to step 9.

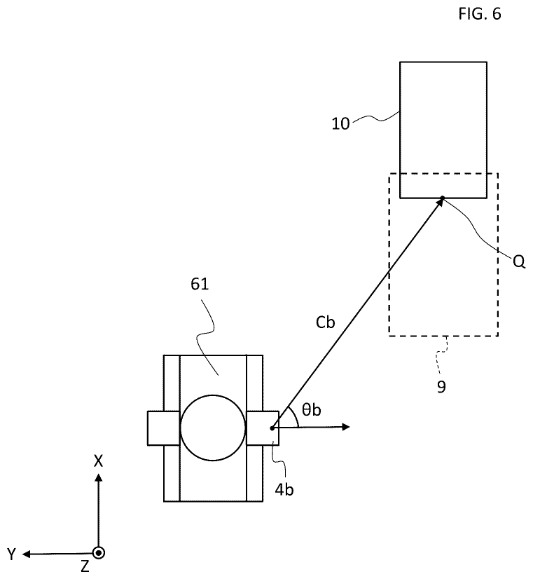

FIG. 6 is a schematic view explaining a determination process relating to the exclusion area in step S7 of FIG. 5, and is a schematic view of the robot 2 viewed from the positive direction of the Z axis (i.e. the upper part of the vertical direction). In FIG. 6, another robot 10, while moving, enters the exclusion area 9. The processor 31 calculates in step S6 the coordinate of a point Q, which represents the position of the object, based on the measurement value Cb at the irradiation angle θb of the sensor 4b. If the coordinate of the point Q, which represents the position of the object, is located inside the exclusion area 9, the processor 31 of the controller 3 does not perform an approach determination process, which will be described below. On the other hand, if the coordinate of the point Q, which represents the position of the object, is located outside the exclusion area 9, the processor 31 performs the approach determination process described below. In this way, the processor 31 can keep a non-human moving object from being determined to be a target by the approach determination process and allow the robot 2 to continue to operate.

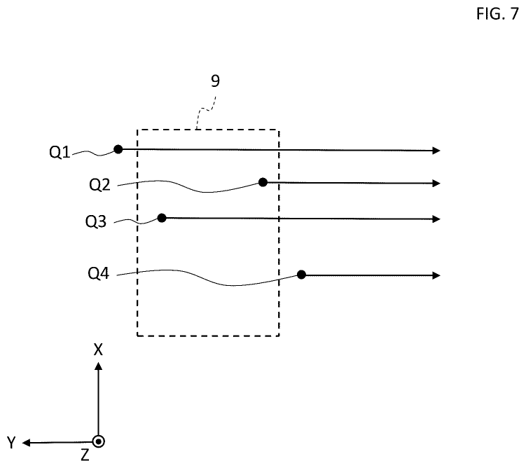

FIG. 7 is a schematic view explaining the approach determination process performed in step 7 of FIG. 5 with respect to the exclusion area 9. FIG. 7 shows the exclusion area 9 viewed from the positive direction of the Z axis (i.e. the upper part of the vertical direction). The processor 31 of the controller 3 uses the Ray-Casting method to determine whether the point representing the object (a moving object) is located outside or inside the exclusion area 9. More specifically, as shown in FIG. 7, the processor 31 draws a line from the tool center point in the horizontal direction, that is, in the negative direction along the Y axis and counts the number of intersections of the drawn line with the boundary lines of the exclusion area 9. If the number of intersections of the drawn line with the boundary lines of the exclusion area 9 is even, as shown in FIG. 7 by the lines running from points Q1 and Q4, the processor 31 determines that points Q1 and Q4 are located outside the exclusion area 9. On the other hand, if the number of intersections of the drawn line with the boundary lines of the exclusion area 9 is odd, as shown in FIG. 7 by the lines running from points Q2 and Q3, the processor 31 determines that points Q2 and Q3 are located inside the exclusion area 9. The Ray-Casting method is applicable to any polygonal areas and only requires a small amount of calculation. Thus, the processor 31 can quickly perform the approach determination process with respect to the exclusion area 9.

Returning to FIG. 5, prior to performing the approach determination process in step S9, the processor 31 calculates distances necessary to make a determination under three approach determination conditions, which will be described below (step S8). The three approach determination conditions are conditions to detect an approach of a moving object to at least a part of the robot 2.

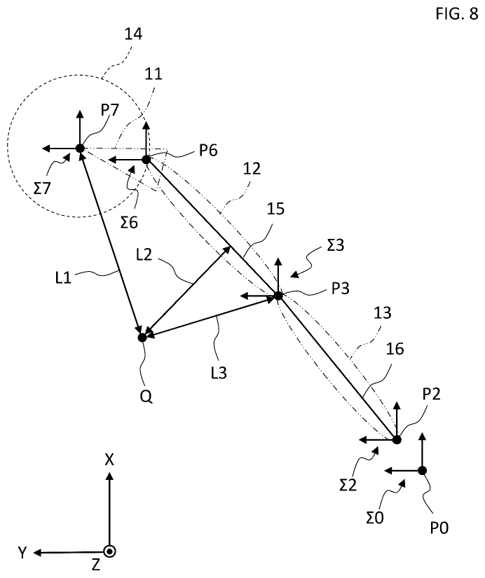

FIG. 8 is a schematic view explaining distances calculated to make a determination under the three approach determination conditions. FIG. 8 schematically shows the robot 2 viewed from the positive direction along the Z axis (the upper part of the vertical direction). The parts of the robot 2 are represented by a triangle 11, an elongated circle 12, and an elongated circle 13 all shown by dash-dot-dot lines which generally show the positions of the parts of the robot 2. The triangle 11 represents the positions of the tool 8, the wrist portion 76 and the attachment portion 77. The elongated circle 12 represent the position of the upper arm 72. The elongated circle 13 represents the position of the lower arm 71. Point Q represents the position of an object found in the coordinate system 20 of the base 6. The processor 31 calculates the coordinates of the origins of the coordinate systems 21 to 26 of the joints of the robot 2 (=points P1 to P6) and the tool center point (=point P7) in the above-described step S1. Also, processor 31 calculates the coordinate of point Q in the above-described step S6.

To satisfy the first condition of the three approach determination conditions, a first distance L1 measured between the tool center point (=point P7) and the point representing the position of the object (=point Q) needs to be smaller than a first threshold value. The center position of a circle 14 shown by a dash line represents the tool center point (=point P7). The first threshold value is set equal to the radius of the circle 14. When the first condition is satisfied, the point representing the position of the object (=point Q) is located inside the circle 14, and thus the object is determined approaching the tool 8.

To satisfy the second condition, a second distance L2 measured between an upper arm line segment 15 representing the longitudinal length and the position of the upper arm 72 and the point representing the position of the object (=point Q) needs to be smaller than a second threshold. The upper arm line segment 15 represents the longitudinal length and the position of not only the upper arm 72 but also the wrist portion 76 and the attachment portion 77. As shown in FIG. 8, a first end of the upper arm line segment 15 constitutes the origin of the coordinate system 26 of the joint relating to the sixth rotational axis J6 (=point P6), and the second end of the upper arm line segment 15 constitutes the origin of the coordinate system 23 of the joint relating to the third rotational axis J3 (=point P3). When the second condition is satisfied, the object is determined approaching the upper arm 72.

To satisfy the third condition, a third distance L3 measured between a lower arm line segment 16 representing the longitudinal length and the position of the lower arm 71 and the point representing the position of the object (=point Q) needs to be smaller than a third threshold. as shown in FIG. 8, a first end of the lower arm line segment 16 constitutes the origin of the coordinate system 23 of the joint relating to the third rotational axis J3 (=point P3), and the second end of the lower arm line segment 16 constitutes the origin of the coordinate system 22 of the joint relating to the second rotational axis J2 (=point P2). When the third condition is satisfied, the object is determined approaching the lower arm 71.

Hereinafter, it will be described how to determine the second distance L2 and the third distance L3. Since the second distance L2 and the third distance L3 can be determined in a similar manner, only the second distance L2 will be taken as an example to explain how to determine the distance. The coordinates of both ends of the upper arm line segment 15 are defined to be A (x1, y1) and B (y1, y2). Also, the coordinate of the position of the object is defined to be Q (x, y). Then, t is defined by Equation (1).

$$[ Equation 1 ]$$

$$t = \frac{\vec{AB} \cdot \vec{AQ}}{{‖ \vec{AB} ‖}^{2}} \\ where \\ \vec{AB} = ( x 2 - x 1 , y 2 - y 1 ) , \vec{AQ} = ( x - x 1 , y - y 1 ) , \\ \vec{AB} \cdot \vec{AQ} : the inner product between \vec{AB} and \vec{AQ} , \\ {‖ \vec{AB} ‖}^{2} : the square of the length of \vec{AB} \qquad ( 1 )$$

When t is equal to or less than zero, the point along the upper arm line segment 15, which is closest to the position of the object, is presented by A, Thus, the second distance L2 is calculated as an Euclidean distance between the points A and Q. When t is equal to or greater than one, the point along the upper arm line segment 15, which is closest to the position of the object, is represented by B. Thus, the second distance L2 is calculated as an Euclidean distance between the points B and Q. When 0<t<1, the point C along the upper arm line segment 15, which is closest to the position of the object, is given by the following equation. Thus, the second distance L2 is calculated as an Euclidean distance between the points C and Q.

$$[ Equation 2 ]$$

$$C = A + t \cdot \vec{AB} \qquad ( 2 )$$

It is preferable that both ends of the upper arm line segment 15 and both ends of the lower arm line segment 16 are located at the origins of the coordinate systems 21 to 26, which represent the joints of the robot 2. In this way, the controller 3 can speedily calculate the first distance L1, the second distance L2 and the third distance L3. This is because the controller 3 also calculates the coordinates of the origins of the coordinate systems 21 to 26 of the joints when calculating the coordinate of the tool center point of the robot 2. Note that the present invention is not being limited to the example in FIG. 8, The first end of the upper arm line segment 15 may, for example, constitutes the origin of the coordinate system 25 of the joint relating to the fifth rotational axis J5 (=point P5). The positions of both ends of the upper arm line segment 15 and both ends of the lower arm line segment 16 may be chosen adaptively according to the number of the joints or the shapes of the parts of the robot 2.

Further, it is preferable that the upper arm line segment 15 and the lower arm line segment 16 have a common end at the origin of the coordinate system 23 of the joint relating to the third rotational axis J3 (=point P3). That is, it is preferable that the elbow portion 75 shown in FIG. 4 of the arm 7 of the robot 2 constitutes the common end of the upper arm line segment 15 and the lower arm line segment 16. In this way, the controller 3 can detect with high accuracy an object approaching the elbow portion 75, which is most likely to protrude among the parts of the arm 7.

Returning to FIG. 5, when at least one of the first, second and third conditions of the three approach determination conditions is satisfied (‘Yes’ in step S9), the processor 31 restricts the movement of the robot 2 (step S10) and terminates the process. Examples of the restriction on the movements of the robot 2 include stopping the movement of the robot 2, slowing the movement speed of the robot 2 and moving the robot 2 in a direction away from the object.

When none of the first, second and third conditions are satisfied (‘No’ in step S9), the processor 31 checks whether or not the process has been completed at all of the irradiation angles for the sensor 4a (step S11). If the process has not been completed at all of the irradiation angles for the sensor 4a (‘No’ in step S11), the processor 31 sets a next irradiation angle for the sensor 4a (step S5) and repeats the loop process from step S3. On the other hand, if the process has been completed at all the irradiation angles for the sensor 4a (‘Yes’ in step S11), the processor 31 starts step S2 to set the initial irradiation angle for the sensor 4b and repeats the loop process from S3 for the sensor 4b to recursively sense at one irradiation angle after another until a judgement in step S11 becomes ‘Yes’. After the judgement performed in step S11 becomes ‘Yes’ for both the sensors 4a and 4b, if the robot 2's movement is restricted, the processor 31 cancels the restriction (step S12), and terminates the process shown in FIG. 5. Examples of the cancellation of the restriction on the robot 2's movement include, for example, restarting the movement of the robot 2, removing the speed limit on the movement of the robot 2 and moving the robot 2 back to the original position. Alternatively, the processor 31 may cancel the restriction on the movement of the robot 2 after a certain period of time has passed since the process has been completed at all of the irradiation angles.

As discussed above, the controller 3 calculates the position of the respective parts of the robot 2, based on the link parameters of the robot 2 and calculates the position of the object, based on the measurement values of the sensors 4a and 4b. Also, the controller 3 performs the approach determination process, in which a first condition is whether the first distance L1 measured between the tool center point and the point representing the position of the object is smaller than the first threshold, a second condition is whether the second distance L2 measured between the upper arm line segment 15 and the point representing the position of the object is smaller than the second threshold, and the third condition is whether the third distance L3 measured between the lower arm line segment 16 and the point representing the position of the object is smaller than the third threshold. If at least one of the first condition, the second condition and the third condition is satisfied, the controller 3 restricts the movement of the robot 2. In this way, the controller 3 can reliably detect an approach of the moving object with respect to both the tool 8 and arm 7 of the robot 2.

Further, the positions of both ends of the upper arm line segment 15 and both ends of the lower arm line segment 16 constitute the origins of the coordinate systems 21 to 26 of the joints of the robot 2. With this arrangement, the controller 3 can speedily calculate the first distance L1, the second distance L2 and the third distance L3.

Furthermore, the controller 3 is preset with the exclusion area 9, which is excluded from the approach determination process. The controller 3 uses the Ray-Casting method to determine whether the point representing the object is located outside or inside the exclusion area 9. If the point representing the position of the object is located outside the exclusion area 9, the controller 3 performs the approach determination process. If the point representing the position of the object is located inside the exclusion area 9, the controller 3 does not perform the approach determination process. This makes it possible to keep a non-human moving object from being determined to be an object by the approach determination process and allow the robot to continue the movement.

Although the monitoring range of each of the sensors 4a and 4b is a horizontal two-dimensional plane around the robot 2, and the first distance L1, the second distance L2, and the third distance L3 are two-dimensional distances in the above descriptions, the embodiments of the present invention are not limited thereto. For example, if the sensors 4a and 4b are three-dimensional cameras that can measure three-dimensional distances from their own positions to an object, the monitoring ranges of the sensors 4a and 4b may be three-dimensional space around the robot 2, and the first distance L1, the second distance L2, and the third distance L3 may be three-dimensional distances.

Although the preferred embodiments of the robot system and the like according to the present invention have been described above with reference to the accompanying drawings, the present invention is not limited to these examples. It is obvious for those skilled in the art that various modification examples or correction examples may be conceived of within the scope of the technical idea disclosed in the present application, and it is understood that they will also naturally fall within the technical scope of the present invention.

What is claimed is:

1. A robot system comprising:
a robot having a base, a robot arm including a lower arm joined to the base and an upper arm joined to the lower arm, and a tool joined to the upper arm;
at least one sensor operable to sense a monitoring range, wherein the sensor is operable to obtain measurement values indicating a distance to an object that is present in the monitoring range; and
a controller comprising at least one processor and at least one memory, wherein the memory stores in advance link parameters of the robot, wherein the controller is programmed to control operation of the robot subsequent to starting the operation of the robot and recursively perform a monitoring process,
wherein the monitoring process comprises:
(a) calculating positional information of each part of the robot based on the link parameters of the robot;
(b) calculating a position of the object based on the measurement values of the sensor;
(c) executing an approach determination process in which a first condition is to determine if a first distance between a tool center point representing a center position of the tool and a point representing the calculated position of the object is smaller than a first threshold, a second condition is to determine if a second distance between an upper arm line segment representing a longitudinal length and a position of the upper arm and the point representing the calculated position of the object is smaller than a second threshold, and a third condition is to determine if a third distance between a lower arm line segment representing a longitudinal length and a position of the lower arm and the point representing the calculated position of the object is smaller than a third threshold; and
(d) restricting movement of the robot when at least one of determinations in the first condition, the second condition and the third condition is affirmative.

2. The robot system according to claim 1, wherein
positions of both ends of the upper arm line segment and both ends of the lower arm line segment constitute origins of coordinate systems of joints of the robot.

3. The robot system according to claim 1, wherein
the memory stores in advance an exclusion area where the approach determination process is not performed;
the processor is programmed to use a Ray Casting method to determine whether the point representing the calculated position of the object is located outside or inside the exclusion area; and
the processor is programmed to, upon determination that the point representing the calculated position of the object is located outside the exclusion area, perform the approach determination process, and upon determination that the point representing the calculated position of the object is located inside the exclusion area, dispense with performing the approach determination process.
